(19) United States
(12) Patent Application Publication
(10) Pub. No.: US 2012/0138410 A1
(43) Pub. Date: Jun. 7, 2012

(54) INTERLOCKING SYSTEM AND METHOD FOR INTERLOCKING A SHAFT-HUB CONNECTION

(75) Inventors: Florian Vogel, Baden-Baden (DE); Marc Uebelacker, Karlsruhe (DE); Peter Speth, Buehl (DE)

(73) Assignee: SCHAEFFLER TECHNOLOGIES AG & CO. KG, Herzogenaurach (DE)

(21) Appl. No.: 13/396,907

(22) Filed: Feb. 15, 2012

Related U.S. Application Data
(63) Continuation of application No. PCT/DE2010/000910, filed on Aug. 2, 2010.

(30) Foreign Application Priority Data
Aug. 24, 2009 (DE) 102009038640.8

(51) Int. Cl. F16D 11/14

(52) U.S. Cl. 192/69.9

(57) ABSTRACT

An interlocking system for a shaft-hub connection comprising a shaft element having an exterior toothing, a hub element having an interior toothing, wherein to interlock the shaft element and the hub element a ring gear having a toothing is provided, and wherein in an interlocked condition the toothing of the ring gear is arranged to be offset by an angle relative to the interior toothing of the hub element and/or relative to the exterior toothing of the shaft element.

### CROSS-REFERENCE TO RELATED APPLICATIONS

This application is filed under 35 U.S.C. §120 and §365(c) as a continuation of International Patent Application No. PCT/DE2010/000910 filed Aug. 2, 2010, which application claims priority from German Patent Application No. 10 2009 038 640.8 filed Aug. 24, 2009, which applications are incorporated herein by reference in their entireties.

### FIELD OF THE INVENTION

The invention relates to an interlocking system for a shaft/hub connection. Furthermore the invention relates to a method for interlocking a shaft/hub connection.

### BACKGROUND OF THE INVENTION

Such an interlocking system is known, for example, from WO 2007/000140 in the form of a clutch system. This interlocking system has a shaft element taking the form of a ring gear of a clutch and having an exterior toothing, and a hub element taking the form of a flange of a damper and having an interior toothing. To ensure proper transmission between the shaft element and the hub element and simultaneously to reduce clunks and rattling resulting from torsional vibration, the proposition is made to provide a number of cutouts in the shaft element and in each cutout to arrange a spring element that has spring arms engaging in the interior toothing of the hub element, thus implementing an interlocking action between the shaft element and the hub element. A disadvantage of this interlocking system is, however, that it is highly complex in constructional terms insofar as it is necessary to form cutouts in the shaft element—a rather expensive process which requires extra processing of the shaft element.

### BRIEF SUMMARY OF THE INVENTION

An object of the invention is to provide an interlocking system for a shaft-hub connection and a method of interlocking a shaft-hub-connection which are characterized by a reduced constructional complexity and consequently contribute to reducing manufacturing costs.

In accordance with the invention, an interlocking system for a shaft-hub connection comprises a shaft element having an exterior toothing, a hub element having an interior toothing, and a toothed ring gear for interlocking the shaft element and the hub element, the toothing of the ring gear being offset by an angle relative to the interior toothing of the hub element and/or relative to the exterior toothing of the shaft element.

The ring gear is preferably arranged on the interlocking system in such a way that the ring gear is capable of carrying out an axial movement along its axis of rotation and of rotating relative to the shaft element and the hub element, respectively, as a result of the axial movement, thus providing a way of mounting the shaft element to the hub element. The axial movement of the ring gear and the resultant rotary movement of the ring gear is implemented by an offset between the toothing of the ring gear and the interior toothing of the hub element and/or the exterior toothing of the shaft element, the offset preferably being present both before the interlocked condition and in the interlocked condition of the shaft-hub connection, with the angle of offset varying between the condition before the interlocking action and the condition during the interlocking action. Due to the fact that there is an offset between the toothing of the ring gear and the interior toothing of the hub element and/or the exterior toothing of the shaft element from the start, the ring gear is moved in an axial direction along its axis of rotation and thus rotates in an essentially tangential manner relative to its axis of rotation when the shaft element is mounted to the hub element or when the hub element is mounted to the shaft element, respectively. For example the offset between the toothing of the ring gear and the interior toothing of the hub element is selected such that the width of a tooth of the exterior toothing of the shaft element is greater than the gap between a tooth of the ring gear toothing and a tooth of the interior toothing of the hub element.

The mounting of the shaft-hub connection may preferably be implemented by providing a thread-in chamfer on the teeth of the exterior toothing of the hub element to be able to slide the teeth of the shaft element into the respective gap between the teeth of the interior toothing of the hub element and the teeth of the toothing of the ring gear, and by initially moving the ring gear in an axial direction and thus causing it to rotate it along its axis of rotation to increase the gap between a tooth of the toothing of the ring gear and a tooth of the interior toothing of the hub element up to a size that is sufficient for being able to fix a tooth of the shaft element in the gap between a tooth of the ring gear and a tooth of the hub element, in particular by a clamping action, thus achieving an interlocking action. Due to the interlocking action, the ring gear is capable of providing a clamping action between the exterior toothing of the shaft element and the interior toothing of the hub element. The toothings of the shaft element, of the hub element, and of the ring gear may thus be interlocked with each other in a direction of relative rotation with respect to each other. Due to the angular positioning of the toothings of the shaft element, of the hub element, and of the ring gear, these can be held in a position relative to each other which ensures that a degree—though a slight degree—of rotary play is present between the toothings in both directions of relative rotation. Due to the preload created in this way and the interlocking action achieved in the process, the amount of wear that occurs on the toothing of the shaft element and of the hub element may be reduced. A particular advantage of the interlocking system of the invention is furthermore that to achieve the interlocking action, the shaft element and the hub element do not need any additional constructional modifications. Instead, only an additional ring gear needs to be provided. Consequently, the constructional complexity of such a shaft-hub connection and thus its manufacturing costs can be considerably reduced.

In accordance with a preferred embodiment of the invention, the ring gear is elastic. Due to its elasticity, the flexibility and rotatability of the ring gear is improved, thus causing an elastic interlock to be implementable that ensures that the toothings, i.e., the teeth of the shaft element, of the hub element, and of the ring gear can be interlocked with each other in a direction of relative rotation with respect to each other. When torque loads occur in one of the directions of relative rotation as a result of torsional vibration, vibration filtration or damping is achieved by the gear ring causing the elastic interlock.

In accordance with a further preferred embodiment, the gear ring may be made of a spring plate. The spring plate has a high degree of elasticity, thus ensuring that an optimum interlock can be achieved. Moreover, the spring plate is preferably very thin and lightweight. In addition, the spring plate only requires a very small amount of installation space, thus causing the ring gear to be insertable in a space-saving way into the shaft-hub connection and at the same time to ensure secure interlocking.

In accordance with yet another preferred embodiment of the invention, the ring gear is fixable to the hub element or to the shaft element. If the ring gear is fixable to the hub element, the ring gear preferably has an interior toothing that is offset by an angle relative to the interior toothing of the hub element. If this is the case, the first step to assemble the shaft-hub connection preferably is to fix the ring gear to the hub element and the second step is to slide the exterior toothing of the shaft element into the gap between the interior toothing of the ring gear and the interior toothing of the hub element by applying a force to the shaft element in order for the shaft element to move the ring gear in an axial direction along its axis of rotation, thus causing a rotation of the ring gear about its axis of rotation until the exterior toothing of the shaft element can be fitted into the gap between the interior toothing of the hub element and the interior toothing of the ring gear. To facilitate insertion of the exterior toothing of the shaft element into the gap, the front face of the teeth of the exterior toothing of the shaft element preferably has a beveled chamfer. If the ring gear is fixable to the shaft element, the ring gear preferably has an exterior toothing that is offset by an angle relative to the exterior toothing of the shaft element. If this is the case, the first step to assemble the shaft-hub connection is to fix the ring gear to the shaft element and the second step to slide the interior toothing of the hub element into the gap between the exterior toothing of the ring gear and the exterior toothing of the shaft element by applying a force to the hub element to cause the hub element to move the ring gear in an axial direction along its axis of rotation, thus causing the ring gear to rotate about its axis of rotation until the interior toothing of the hub element can be locked in the gap between the exterior toothing of the shaft element and the exterior toothing of the ring gear. To facilitate insertion of the hub element into the gap, the front face of the teeth of the interior toothing of the hub element preferably has a beveled chamfer.

In accordance with a further preferred aspect of the invention, the ring gear includes at least two web elements for fixing the ring gear to the hub element or to the shaft element. The web elements are preferably formed on that side face of the ring gear that is opposite the side face that has the toothing, and preferably extend away from the outer circumferential surface or the inner circumferential surface of the ring gear at a given distance in an arm-shaped manner corresponding to the shape of the circumferential surface of the ring gear. Due to the web elements, it is possible to fix the ring gear at a certain distance from the interior toothing of the hub element or from the exterior toothing of the shaft element to ensure the highest degree of flexibility of the ring gear in terms of its movement during the assembling of the shaft-hub connection and thus to ensure optimum elastic interlocking.

The web elements are preferably elastic. Due to the elasticity of the web elements, the ring gear can be moved in the axial direction and rotated as elastically as possible, thus ensuring that the toothing of the ring gear can be moved in the axial direction and rotated relative to the interior toothing of the hub element and the exterior toothing of the shaft element. Due to the resultant torsion of the ring gear caused by rotating the angular offset of the interior toothing of the hub element and/or the exterior toothing of the shaft element relative to the toothing of the ring gear, an interlocking torque may be created that eliminates play or at least may eliminate play in a certain range in the shaft-hub connection or rather in the shaft-hub toothing. The preloading torque or interlocking torque can be detected and verified in experiments once the required angular offset between the hub element and/or the shaft element and the ring gear has been determined by the calculation of tolerances, for instance by the finite element method. By appropriately adapting the elasticity or constructional shape of the web elements the preloading torque and/or the interlocking torque may be increased or reduced to be able to implement an optimum interlocking action for a shaft-hub connection.

In accordance with a further feature of the invention, the web elements may be of leaf spring-like construction. The leaf spring-like web elements are preferably made of a flat strip of metal integrally connected to the ring gear. The strip of metal may be preloaded into an arcuate shape. The web elements are preferably formed in an arcuate shape along at least a portion of the outer circumferential surface or along at least a portion of the interior circumferential surface of the ring gear. In this context, the length of the leaf spring-like web elements is preferably constant; a fact which means that length of the leaf spring-like web elements cannot be varied by the application of tensile loads or pressure. Due to the constant length of the leaf spring-like web elements it is possible for the ring gear to rotate upon an axial movement of the ring gear along its axis of rotation.

In accordance with a preferred embodiment of the invention, the web elements are connected to the hub element or the shaft element by a rivet connection. For this purpose, those ends of the web elements that are opposite the ends at which the web element is connected to the ring gear itself preferably has a bore into which the rivet connection is insertable. Due to the rivet connection easy fastening of the ring gear to the hub element or to the shaft element is possible. The fact that the fixing of the ring gear is done at the web elements instead of at the region of the toothing of the ring gear ensures that the ring gear is free to move in an axial direction and to rotate in an optimum way for the purpose of interlocking the shaft element and the hub element. The teeth of the toothing of the ring gear are preferably in defined positions relative to the bores to the hub element or to the shaft element required for fixing the ring gear, depending on whether the ring gear is fixed to the hub element or to the shaft element. Another preferred feature of the invention is that when the ring gear is fixed to the hub element, the positions of the teeth of the interior toothing of the hub element relative to the bores to the ring gear that are required for fixing purposes are defined. If the ring gear is fixed to the shaft element, it is preferred for the teeth of the exterior toothing of the shaft element to be in defined positions relative to the bores to the ring gear that are required for fixing purposes. The rivet connection may be replaced by any other form-fitting connection, for example by a screw connection.

The invention further relates to a torque transmission system comprising a mass flywheel and a twin clutch, the mass flywheel and the twin clutch being interconnected by an interlocking system designed in accordance with one or more features as described above.

The shaft element of the interlocking system forms a secondary-side power take-off of the twin clutch, with the hub element of the interlocking system forming a secondary-side drive hub of the mass flywheel, which may be of one-part or multiple-part construction. In known torque transmission systems of the prior art the connection between the mass flywheel and the twin clutch is achieved by a non-tangentially preloaded shaft-hub connection. The resultant play in the non-tangentially preloaded shaft-hub connection may cause noise in the idle stage. This noise may result from the impinging of the interior toothing of the hub element and of the exterior toothing of the shaft element due to the cyclic irregularity of the combustion engine. The use of an interlocking system of the invention in such a clutch system may contribute to avoiding these disadvantages. Using the interlocking system of the invention, an interlocking torque may be applied in such a shaft-hub connection to eliminate play in the shaft-hub connection up to a certain torque.

Moreover, the clutch system may be a twin clutch including a driving collar provided in between an arc spring flange and an interlocking system of the invention for torque transmission and axial tolerance compensation.

The advantages described above with respect to the interlocking system of the invention apply in an analogous manner to the clutch system of the invention.

The invention further refers to a method of interlocking a shaft-hub connection wherein a shaft element having an exterior toothing and a hub element having an interior toothing are connected by arranging a toothed ring gear on the shaft-hub connection in such a way that the toothing of the ring gear is offset by an angle relative to the interior toothing of the hub element and/or relative to the exterior toothing of the shaft element.

In a first step, the ring gear is arranged on the hub element or on the shaft element with the toothing of the ring gear offset relative to the interior toothing of the hub element or relative to the exterior toothing of the shaft element. If the ring gear is attached to the hub element, the second step is to insert exterior toothing of the shaft element into the respective gaps formed between the teeth of the interior toothing of the ring gear and the interior toothing of the hub element by the ring gear moving in an axial direction along its axis of rotation and simultaneously rotating gear relative to the hub element. In the process, the ring gear rotates until the teeth of the exterior toothing of the shaft element can be clamped in the gap between the interior toothing of the hub element and the interior toothing of the ring gear. If in the first step the ring gear is arranged on the shaft element, the angular offset is between the exterior toothing of the ring gear and the exterior toothing of the shaft element. Then in the second step, the hub element is preferably fixed to the shaft element by inserting the teeth of the interior toothing of the hub element into the respective gaps between the exterior toothing of the shaft element and the exterior toothing of the ring gear by rotating the ring gear relative to the shaft element due to the ring gear's movement in the axial direction along its axis of rotation.

The advantages described above with respect to the interlocking system of the invention apply in an analogous manner to the method of the invention.

In accordance with a preferred embodiment of the invention, the ring gear is moved in an axial direction along its axis of rotation when the shaft element and the hub element are being connected, and the movement in the axial direction causes the ring gear to rotate in a direction tangential to its axis of rotation. As a result of the tangential rotation of the ring gear relative to its axis of rotation the toothing of the hub element or of the shaft element, respectively, is easy to insert into the gap between the toothing of the ring gear and the exterior toothing of the shaft element or into the gap between the toothing of the ring gear and the interior toothing of the hub element, respectively, to ensure a quick and easy assembly.

### BRIEF DESCRIPTION OF THE DRAWINGS

The invention will be explained in greater detail based on preferred exemplary embodiments and with reference to the appended drawings, wherein:

FIG. 1 is a diagrammatic representation of a first embodiment of a ring gear of the invention;

FIG. 2 is a diagrammatic representation of a hub element and the ring gear shown in FIG. 1;

FIG. 3 is a diagrammatic representation of a further hub element with the ring gear shown in FIG. 1 and an assembled shaft element;

FIG. 4 is an enlarged diagrammatic representation of a section of the connection between the ring gear, the shaft element, and the hub element shown in FIG. 3;

FIG. 5 is a diagrammatic representation of a second embodiment of a ring gear arranged on a hub element;

FIG. 6 is an enlarged diagrammatic representation of a section of the illustration shown in FIG. 5;

FIG. 7 is a diagrammatic representation of a shaft-hub connection including the ring gear shown in FIG. 5 and the hub element in an interlocked condition; and,

FIG. 8 is an enlarged diagrammatic representation of a section of the shaft-hub connection shown in FIG. 7.

### DETAILED DESCRIPTION OF THE INVENTION

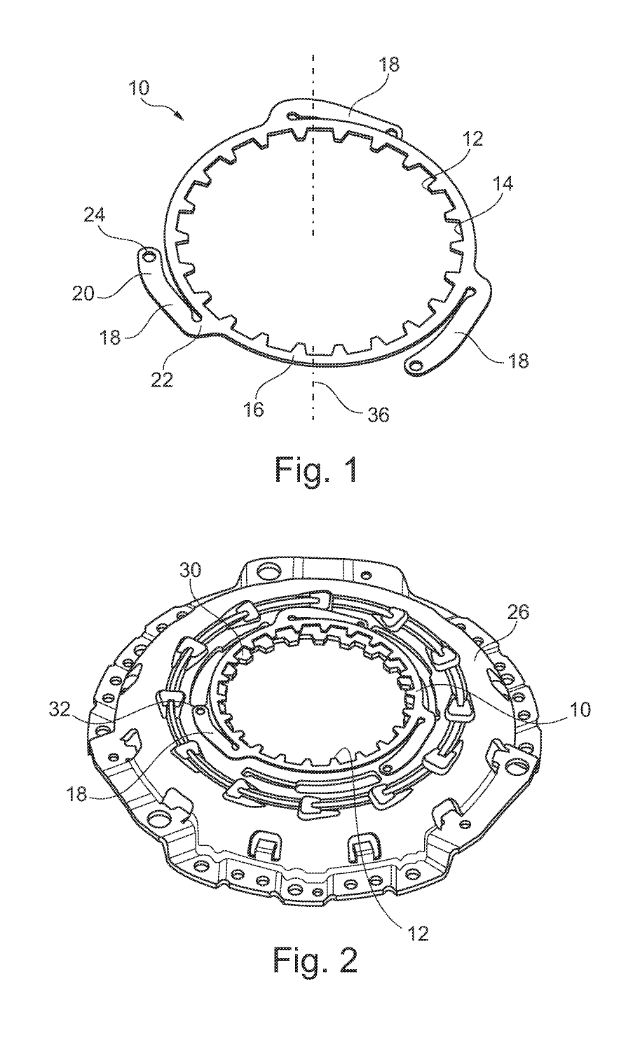

FIG. 1 illustrates a first embodiment of the ring gear 10 of the invention to be used for interlocking a shaft-hub connection. On its inner circumferential surface 14 the ring gear 10 has an interior toothing 12. On its outer circumferential surface 16, the ring gear 10 has web elements 18 that are of leaf spring-like construction. The illustrated ring gear 10 has three leaf spring-like web elements 18. However, it is likewise possible to provide two or more than three leaf spring-like web elements 18 on the ring gear 10. On a first end 20 of the web elements located opposite a second end 22 of the web elements 18 that are immediately joined to the ring gear 10, a respective bore 24 is provided to connect the ring gear 10 to a hub element 26 or a shaft element 28, for instance by means of a rivet connection 32 as shown in FIG. 2. The leaf spring-like web elements 18 are preferably of arcuate shape, thus extending along at least a portion of the outer circumferential surface 16 of the ring gear 10. The ring gear 10 and in particular the web elements 18 of the ring gear 10 in particular have a high degree of elasticity in particular along their longitudinal axis. The length of the web elements 18 preferably remains constant when the ring gear moves in the axial direction and rotates. The ring gear 10 is preferably made of a very thin sheet metal preferably in the shape of a spring plate.

FIG. 2 illustrates the ring gear 10 shown in FIG. 1 fixed to a hub element 26. The hub element 26 preferably forms a secondary-side drive hub of a dual mass flywheel and is designed as a cover in FIG. 2. As shown in FIG. 2, the interior toothing 12 of the ring gear is offset by an angle relative to the interior toothing 30 of the hub element 26. Furthermore the teeth 12 of the ring gear preferably are of smaller width than the teeth 30 of the hub element 26. Rivets 32 are arranged in the bores 24 of the ring gear 10 and in bores provided in the hub element 26 to fix the ring gear 10 to the hub element 26.

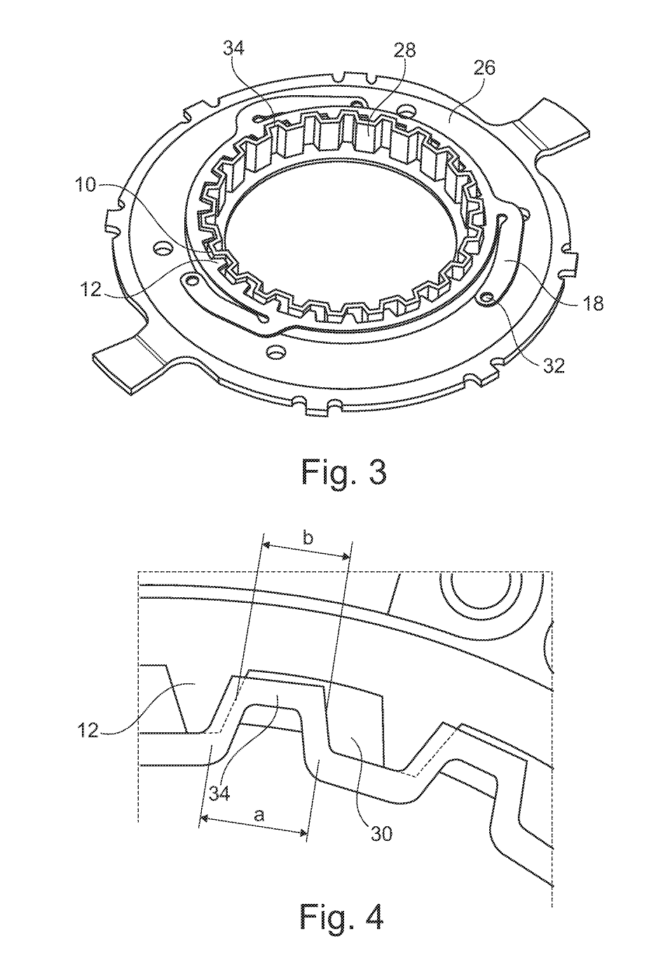

FIG. 3 illustrates a shaft-hub connection in an interlocked condition. A shaft element 28 that has an exterior toothing 34 engages and is fixed in a gap formed between the interior toothing 12 of the ring gear 10 and the interior toothing 30 of the hub element 26, thus implementing an interlocking action or a preload of the shaft-hub connection. In the illustrated example, the shaft element 28 is preferably designed as a retainer ring; and the retainer ring or rather the shaft element 28 preferably forms a secondary-side power take-off of a twin clutch. The front faces of the teeth of the exterior toothing 34 of the shaft element 28 have a beveled chamfer to facilitate attachment of the teeth of the exterior toothing 34 of the shaft element 28 in the gap between the teeth of the toothing 12 of the ring gear 10 and the teeth of the interior toothing 30 of the hub element 26.

FIG. 4 is an enlarged view of the shaft-hub connection shown in FIG. 3 illustrating the tooth width a of the shaft element 28 relative to the gap b between a tooth of the toothing 12 of the ring gear 10 and a tooth of the toothing 30 of the hub element 26. Before the interlocked condition is attained, the gap b has a much smaller width than the tooth width a of the shaft element 28. It is the movement of the ring gear 10 in the axial direction along its axis of rotation 36 and the resultant rotation of the ring gear 10 in a direction tangential to its axis of rotation 36 that causes the gap b between the tooth of the toothing 12 of the ring gear 10 and the tooth of the interior toothing 30 of the hub element 26 to widen until the width of the gap b essentially corresponds to the tooth width a of the shaft element 28. The tooth of the exterior toothing 34 of the shaft element 28 is thus clamped between a tooth of the toothing 12 of the ring gear 10 and a tooth of the interior toothing 30 of the hub element 26.

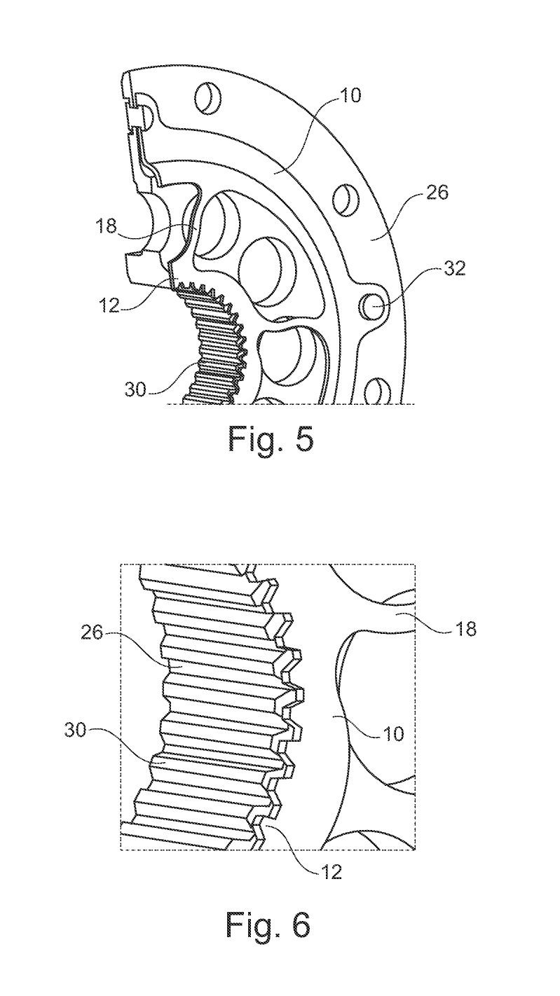

FIGS. 5 to 8 illustrate a second embodiment of the shaft-hub connection.

FIG. 5 illustrates a hub element 26 to which a ring gear 10 designed as a spring plate is fixed by a rivet connection 32. On its inner circumferential surface the ring gear 10 has an interior toothing 12. Along its outer circumferential surface 16 elastic web elements 18 are formed. These elastic web elements 18 extend away from the outer circumferential surface 16 in a radial direction.

FIG. 6 illustrates an enlarged detail of the ring gear 10 and hub element 26 illustrated in FIG. 5. In this illustration, the offset between the interior toothing 12 of the ring gear 10 and the interior toothing 30 of the hub element 26 is visible.

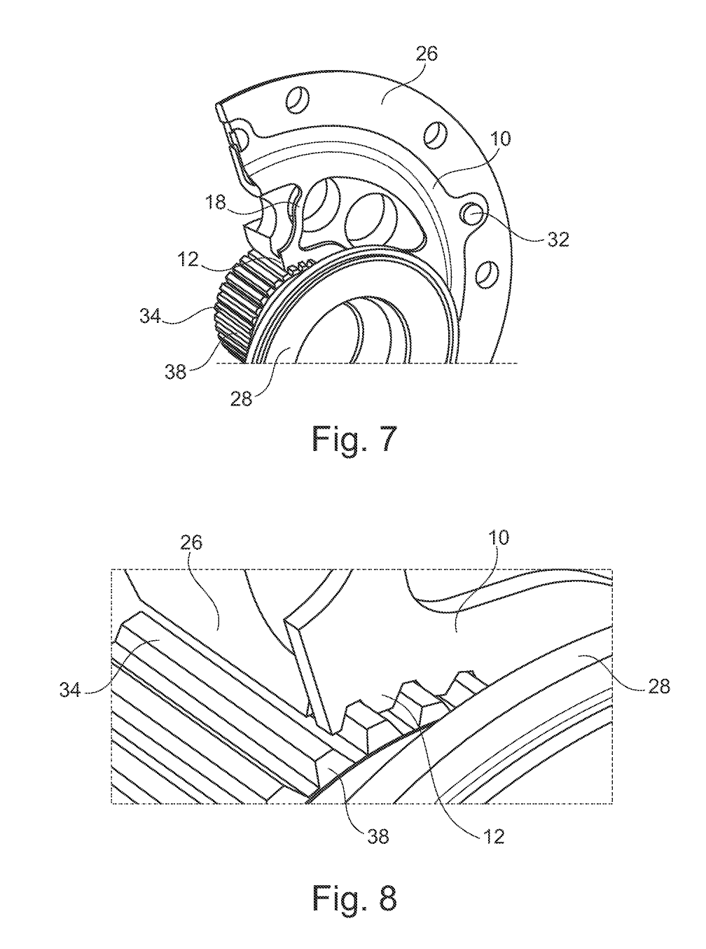

FIG. 7 illustrates the shaft-hub connection in an interlocked condition with the exterior toothing 34 of the shaft element 28 engaging in a gap between the interior toothing 12 of the ring gear 10 and the interior toothing 30 of the hub element 26. This can be seen more clearly in FIG. 8, which is an enlarged detail of the connection shown in FIG. 7.

FIG. 8 clearly shows that the teeth of the exterior toothing 34 of the shaft element 28 have a beveled chamfer on its front face 38 to facilitate insertion of the teeth of the exterior toothing 34 of the shaft element 28 into the gap between the teeth of the toothing 12 of the ring gear 10 and the teeth of the interior toothing 30 of the hub element 26.

The interlocking system shown in FIGS. 1 to 4 is preferably usable in twin clutches. The interlocking system shown in FIGS. 5 to 8 is preferably used in damper systems.

Owing to the interlocking system of the invention, it is possible in particular to eliminate noise in the vehicle caused by play in the shaft-hub connection between twin clutch damper and twin clutch transmission, in particular in the form of clacking teeth.

### REFERENCE NUMERALS AND DESIGNATIONS

10 ring gear
12 toothing
14 inner circumferential surface
16 outer circumferential surface
18 web element
20 first end
22 second end
24 bore
26 hub element
28 shaft element
30 toothing
32 rivet connection
34 toothing
36 axis of rotation
38 chamfer

What is claimed is:

1. An interlocking system for a shaft-hub connection comprising a shaft element (28) having an exterior toothing (34), a hub element (26) having an interior toothing (30), wherein to interlock the shaft element (28) and the hub element (26) a ring gear (10) having a toothing (12) is provided, and wherein in an interlocked condition the toothing (12) of the ring gear (10) is arranged to be offset by an angle relative to the interior toothing (30) of the hub element (26) and/or relative to the exterior toothing (34) of the shaft element (28).

2. The interlocking system as set forth in claim 1, wherein the ring gear (10) is embodied to be elastic.

3. The interlocking system as set forth in claim 1, wherein the ring gear (10) is made of a spring plate.

4. The interlocking system as set forth in claim 1, wherein the ring gear (10) is fixable to the hub element (26) or to the shaft element (28).

5. The interlocking system as set forth in claim 4, wherein the ring gear (10) has at least two web elements (18) for fixing the ring gear (10) to the hub element (26) or to the shaft element (28).

6. The interlocking system as set forth in claim 5, wherein the web elements (18) are embodied to be elastic.

7. The interlocking system as set forth in claim 5, wherein the web elements (18) are of leaf spring-like construction.

8. The interlocking system as set forth in claim 5, wherein the web elements (18) are connectible to the hub element (26) or to the shaft element (28) by a rivet connection (32).

9. A torque transmission system comprising a mass flywheel and a twin clutch, the mass flywheel and the twin clutch being connected to each other by means of an interlocking system as set forth in claim 1.

10. A method of interlocking a shaft-hub connection in which a shaft element (28) having an exterior toothing (34) is connected to a hub element (26) having an interior toothing (30), comprising the step of arranging a ring gear (10) that has a toothing (12) on the shaft-hub connection in such a way that the toothing (12) of the ring gear (10) is arranged to be offset by an angle relative to the interior toothing (30) of the hub element (26) and/or relative to the exterior toothing (34) of the shaft element (28).

11. The method as set forth in claim 10, comprising the step of moving the ring gear (10) in an axial direction along its axis of rotation (36) and causing the ring gear (10) to rotate in a direction tangential to its axis of rotation (36) in the process due to the axial movement when the shaft element (28) is connected to the hub element (26).
